(19) United States
(12) Patent Application Publication
(10) Pub. No.: US 2005/0255833 A1
(43) Pub. Date: Nov. 17, 2005

(54) Message aggregation system and method for a mobile communication device

(75) Inventor: Shahar Bar-Or, Ramat Hasharon (IL)

Correspondence Address: FARSHAD JASON FARHADIAN;CENTURY IP LAW GROUP, P.O. BOX 7333, NEWPORT BEACH, CA, 92658-7333, US

(73) Assignee: Mobile (R&D) Ltd.

(21) Appl. No.: 10/846,187

(22) Filed: May 13, 2004

(51) Int. Cl. H04B 7/00

(52) U.S. Cl. 455/412.1; 455/517

(57) ABSTRACT

A method of collective message transmission from a network server to a mobile device in a mobile communication network is provided. The method comprises aggregating one or more messages generated for real-time transmission to the mobile device in a queue; and collectively transmitting the one or more messages in the queue to the mobile device after a threshold delay period has lapsed.

### BACKGROUND

1. Field of Invention

The present invention relates generally to mobile communication services and, more particularly, to a system and method for aggregating messages directed to a mobile communication device in order to limit power consumption.

2. Copyright & Trademark Notices

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

3. Related Art

Mobile devices such as cellular phones and personal digital assistants (PDAs) are generally battery operated. Despite recent improvements in battery life and the related technologies, it is still quite important to manage the operation of a mobile device such that the battery life is maximized. This is particularly important as mobile devices are operated to handle a great variety of tasks that go beyond mere voice communications.

Text messaging is an example of one of the many functions performed by a mobile device. Using a text messaging service, a user can communicate with one or more other individuals by way of sending and receiving text to their designated addresses. A useful advantage of text messaging services is the service's capability to notify a user of the connection status of other users to the system.

That is, the text messaging service, depending on implementation, can provide the user with the most current connection status of other users. For example, when a first user logs on to the text messaging service, the service provider forwards a notification to a second user indicating that the first user is logged on. Other status notifications may be generated and forwarded when the user is logged off, unavailable, busy, on the phone, etc.

If a user has configured the mobile device to be notified of such status changes for multiple other users (e.g., buddies on a buddy list), then it is conceivable that the mobile device will receive a substantial number of notification messages every time the status of one of these multiple users changes. This can result in substantial traffic being directed to the mobile device.

Since most of said messages are generated in real-time, it is likely for the mobile device to receive the messages in random intervals. Each time the mobile device receives a message, the mobile device will wake up from power conservation mode to process the received message. When the messages are received frequently, the mobile device will have to also wake up frequently. This unnecessarily drains the battery, particularly if the receipt of such messages in real-time is unimportant to the user.

Thus, an improved messaging system and method is desirable that can overcome the above shortcomings.

### SUMMARY

The present disclosure is directed to a system and corresponding methods that facilitate the optimization of battery life for a mobile communication device by queuing real-time messages directed to the mobile device. The queued messages are forwarded to the mobile device after a threshold time period has lapsed.

For purposes of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, a method for collective message transmission from a network server to a mobile device in a mobile communication network is provided. The method comprises aggregating one or more messages directed to the mobile device in a queue; collectively transmitting the one or more messages in the queue to the mobile device after a threshold delay period has lapsed.

The threshold delay period is set by the mobile device. The mobile device forwards a delay request to the network server. The delay request comprises the threshold delay period. The one or more messages may be aggregated in the queue based on message type or according to sender information. The mobile device is in a power saving mode when the one or more messages are aggregating in the queue.

In one embodiment, the mobile device switches from a power saving mode to a processing mode, to process the one or more messages that are collectively transmitted to the mobile device. The one or more messages may comprise status information about a user using a device connected to the mobile communication network. In one embodiment, the mobile device is a cellular telephone.

In accordance with another embodiment, the system for optimizing power consumption in a mobile device connected to a communication network is provided. The system comprises a mechanism for aggregating one or more messages directed to the mobile device in a queue; and a mechanism for collectively transmitting the one or more messages in the queue to the mobile device after a threshold delay period has lapsed.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 illustrates an exemplary communications environment, in accordance with one or more embodiments of the invention;

FIG. 2 is a flow diagram of a method for aggregating messages directed to a mobile device, in accordance with one or more embodiments; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

An electronic system and corresponding methods, according to an embodiment of the present invention, facilitate and provide a method and system for optimizing power consumption in a mobile communication device by submitting an aggregation request to the service provider.

Electronic services, services, and online services are used interchangeably herein. The services provided by the system of this invention, in one or more embodiments, are provided by a service provider. A service provider is an entity that operates and maintains the computing systems and environment, such as server systems and infrastructures that enable the delivery of information. Typically, server architecture includes components (e.g., hardware, software, and communication lines) that store and offer electronic or online services.

In the following, numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

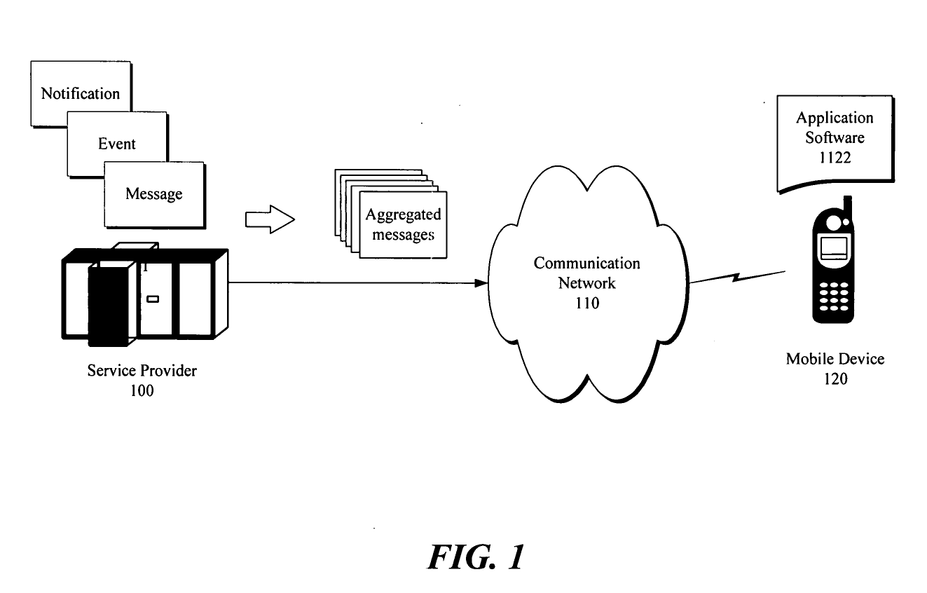

Referring to the drawings, FIG. 1 illustrates an exemplary communications environment in which the system of the present invention may operate. In accordance with one aspect of the system, the system environment comprises a service provider 100, a communication network 110, and a mobile device 120. The service provider 100 and mobile device 120 are connected by way of the communication network 110. The terms “connected,” “coupled,” or any variant thereof, mean any connection or coupling, either direct or indirect, between two or more elements. The coupling or connection between the elements can be physical, logical, or a combination thereof.

In one embodiment, the communication network 110 provides the medium and infrastructure for transmitting digital or analog signals between service provider 100 and mobile device 120. In certain embodiments, mobile device 120 is a cellular telephone and communication network 110 is a wireless telephone network, for example. Mobile device 120, service provider 100 and communication network 110, however, may be implemented over any type of mobile, fixed, wired or wireless communication technology (e.g., landline telephony, cellular, radio, radar, infrared, etc.).

One of ordinary skill in the art will appreciate that communication network 110 may advantageously be comprised of one or a combination of various types of networks without detracting from the scope of the invention. Such networks can, for example, comprise personal area networks (PANs), local area networks (LANs), wide area networks (WANs), public, private or secure networks, value-added networks, interactive television networks, wireless communications networks, two-way cable networks, satellite networks, interactive kiosk networks, cellular networks, personal mobile gateways (PMGs) and/or any other suitable communications networks that can provide a means of communication between mobile device 120 and service provider 100.

In some embodiments, communication network 110 can be a part of the world wide web (i.e., the Internet). The Internet, in a well-known manner, connects millions of computers world wide through standard common addressing systems and communications protocols (e.g., Transmission Control Protocol/Internet Protocol (TCP/IP), HyperText Transport Protocol) creating a vast communications network.

In either context, mobile device 120 can communicate with service provider 100 to send and receive electronic packets of information, in form of electronic requests and responses. In a particular embodiment, the packets are constructed based on a text messaging service, such as short messaging service (SMS) or instant messenger (IM) service. SMS and IM enable short messages to be sent and transmitted from a mobile device 120, such as a cell phone.

SMS and IM are supported in the mobile telephony technology and other digital-based mobile communications systems. Similar to e-mail, short messages and instant messages are stored and forwarded by a service provider 100. Advantageously, SMS and IM messages and requests are transmitted over control channels and data channels to provide for immediate transmission of messages. SMS is implemented over the control channel, while IM is typically implemented over the data service protocols (e.g., Wireless Village protocol over TCP/IP).

Accordingly, in one embodiment, service provider 100 services requests submitted by one or more mobile devices 110. In certain embodiments, service provider 100 is back end server that forwards text messages to a network address (e.g., IP address) specified in a request. Service provider 100, however, can provide any type of electronic service, in accordance with other aspects of the system. For example, in addition to text messaging services, imaging, voice, streaming audio/video, and other communication services may be supported and delivered to a mobile device 120 by service provider 100.

In one embodiment, service provider 100 is a wireless communications service provider (e.g., Sprint, AT&T, Verizon, etc.) that can track the connection status of devices connected to communication network 110. In embodiments of the invention that are implemented using IM technology, service provider 100 may comprise America On Line (AOL), Microsoft Network (MSN) and Yahoo, for example. Depending on implementation, in one embodiment, service provider 100 communicates the connection status of selected devices to mobile device 120. That is, if the status of a device connected to the network changes from active to inactive, for example, this change of status is reported to mobile device 120 by way of a notification message. For example, this status update procedure may be applied to the status of members of a communication group (i.e., a buddy list) in SMS or IM service.

In addition to change of status messages and text messages, other message types may be also forwarded to mobile device 120. In some embodiments, service provider 100 may forward one or more messages to mobile device 120 based on occurrence of certain events in real-time. For example, a user may subscribe to a financial, news, or sports broadcasting service which would forward a message to mobile device 120 in response to a stock price change, a heightened security level, or a game's score result.

To manage the frequency with which the above messages are forwarded to mobile device 120, application software 1122 is installed or executed on one of mobile device 120, service provider 100, a third party portal, or a combination of said systems. As used herein, the terms mobile device, third party portal, service provider and communication network are to be viewed as designations of one or more computing environments that comprise application, client or server software for servicing requests submitted by respective software included in devices or other computing systems connected there to. These terms are not to be otherwise limiting in any manner. The application software, for example, may be comprised of one or more modules that execute on one or more computing systems, as described in further detail below.

In accordance with one aspect of the invention, application software 1122 is implemented to allow a user to select the frequency with which messages are to be sent to mobile device 120. Application software 1122 allows the user to select a time delay after which pending messages for mobile device 120 are to be forwarded to mobile device 120 from service provider 100 or other resources. In this manner, mobile device 120 can elect to receive messages with a delay rather than receiving the message in real-time.

Thus, for example, where service provider 100 is a SMS or IM provider, changes in status of devices connected to communication network 110 are reported to mobile device 120 in predetermined time intervals, instead of as soon as the change in status occurs. Similarly, a user may request service provider 100 to also delay the transmission of SMS or IM messages until a certain number of messages are pending in the transmit queue of service provider 100, or until after a delay threshold period has lapsed. In alternative embodiments, the a delay threshold may be set or adjusted either manually or automatically by service provider 100 or mobile device 120 in accordance with the user profile, length of activity, or other factors. For example, if the user does not set the delay threshold then a default value may be assigned automatically by service provider 100 or mobile device 120.

It should be noted that the above exemplary embodiments are not to be construed to limit the scope of the invention to a singular service provider 100, or application software 1122 that executes exclusively on the mobile device 120, or a communication environment that is exclusively based on SMS or IM technology.

As noted above, application software 1122 may be implemented on a device or a system other than mobile device 120. For example, application software 1122 or its components may be implemented, installed, and executed either in a singular or in a distributed environment. That is, certain components of the application software may be installed and executed on mobile device 120, while other components may be executed and installed on a third party portal, one or more service providers 100, or other systems attached thereto.

The method of this invention may be also applied to other messaging services or communication protocols that are used to report status changes, or transmit various types of content to one or more mobile devices 120 connected to one or more service providers 100. Furthermore, in certain embodiments, mobile device 120 may selectively request that messages of certain type to be subject to delayed transmission, while other message types to be forwarded in real-time. For example, user status update notification messages may be selected as subject to delay, while news related messages may be selected for real-time transmission.

In a similar manner, in one embodiment, a user may select an option such that messages or status notifications associated with a group of devices or profiles (e.g., a buddy list) not to be subject to delay, while all other messages are to be delivered with a predetermined delay threshold. As such, application software 1122, in one embodiment, supports a system for allocating different delay thresholds for different groups of devices or profiles. For example, finance related events (e.g., change in stock prices) may be set to have a 30 minute delay threshold, sport related events (e.g., game scores) may be set to have a 5 minute delay threshold, and important news related events (e.g., heightened security alerts) may be set to have a zero threshold.

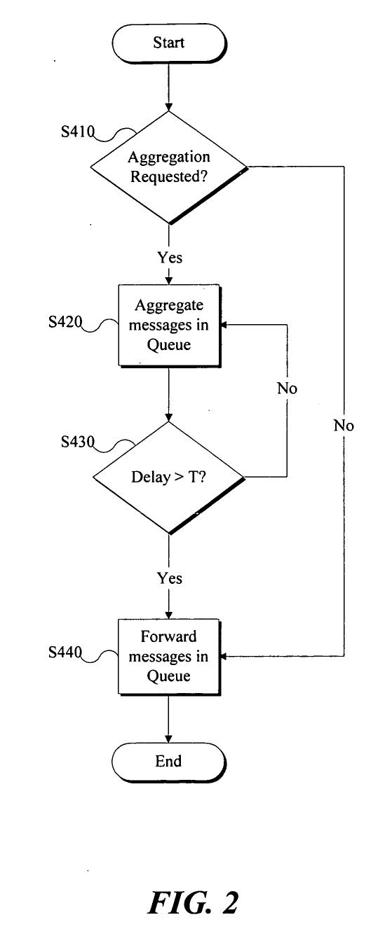

Referring to FIGS. 1 and 2, in accordance with one aspect of the invention, application software 1122 or a component thereof is executed on service provider 100 to determined if a request is submitted by mobile device 120 to delay transmission of any messages by way of aggregating messages (S410). If no such request is presented, then service provide 100 continues to transmit messages to mobile device 120 in real-time. That is, as soon as a message is ready for delivery to mobile device 120, the message is placed on a transmission queue (not shown) of service provider 100 and is sent to mobile device 120.

When the request is submitted by mobile device 120, service provider 100 aggregates messages directed to mobile device 120 in a transmit queue in accordance with the instructions provided in the request (S420). That is, service provider 100 processes the aggregation request and determines the length of delay threshold that is to be applied, and also the type of messages that are to be delayed.

Accordingly, the designated messages are queued as they are generated or received by service provider 100. As the messages are queued for transmission, service provider 100 monitors the aggregation time to determine if the designated delay threshold is satisfied (S430). If the threshold time has expired, then the messages that are pending in the transmit queue are sent to mobile device 120 collectively (S440).

This cumulative approach for transmitting messages advantageously allows mobile device 120 to remain in a power saving mode for a longer period of time because mobile device 120 will be no longer woken up at random intervals to process individual messages transmitted to it in real-time. That is, mobile device 120 receives messages collectively from service provider 100, and processes the received messages in one batch. Mobile device 120 then switches to power saving mode (i.e., sleep mode) until the next batch of messages arrives. When the next delay threshold is satisfied, the next batch of messages are transmitted to mobile device 120.

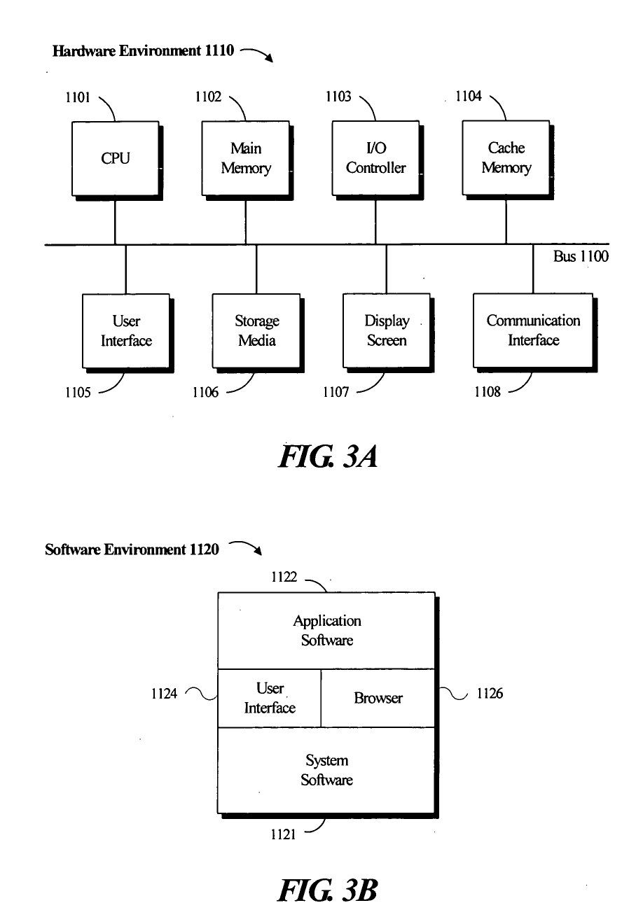

In one or more embodiments of the system, service provider 100, communication network 110, and mobile device 120 comprise a controlled computing system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments.

Software environment 1120 is divided into two major classes comprising system software 1121 and application software 1122. System software 1121 comprises control programs, such as the operating system (OS) and information management systems that instruct the hardware how to function and process information.

Application software 1122 is a program that performs a specific task. In embodiments of the invention, system and application software are implemented and executed on one or more hardware environments to accommodate the delayed transmission of messages addressed to mobile device 120 in accordance to the conditions set forth above.

Referring to FIG. 3A, an embodiment of application software 1122 can be implemented as computer software in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a network card, a modem, or an integrated services digital network (ISDN) card, etc.), and a system synchronizer (e.g., a clock).

Processor 1101 may or may not include cache memory 1104 utilized for storing frequently accessed information. A communication mechanism, such as a bi-directional data bus 1100, can be utilized to provide for means of communication between system components. Hardware Environment 1110 is capable of communicating with local or remotes systems connected to a communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless communication unit (e.g., cellular phone), or other similar hardware platforms that have information processing and/or data storage and communication capabilities. For example, in embodiments of the system mobile device 120 may be a PMG phone or equivalent.

In embodiments of the system, communication interface 1108 can send and receive electrical, electromagnetic, or optical signals that carry digital data streams representing various types of information including program code. If communication is established via the Internet, hardware environment 1110 may transmit program code through an Internet connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are CD-ROM disks, ROM cards, floppy disks, magnetic tapes, computer hard drives, and network server systems.

In one or more embodiments of the invention, processor 1101 is a microprocessor manufactured by Motorola, Intel, or Sun Microsystems Corporations. The named processors are for the purpose of example only. Any other suitable microprocessor, microcontroller, or microcomputer may be utilized.

Referring to FIG. 3B, software environment 1120 is stored in storage media 1106 and is loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software such as an operating system that controls the low-level operations of hardware environment 1110. Low-level operations comprise the management of the system's resources such as memory allocation, file swapping, and other core computing tasks. In one or more embodiments of the invention, the operating system comprises at least one of Symbian, Nucleus, Microsoft Windows, Palm, or Macintosh operating systems. However, any other suitable operating system may be utilized.

Application software 1122 can comprise one or more computer programs that are executed on top of system software 1121 after being loaded from storage media 1106 into memory 1102. In a client-server architecture, application software 1122 may comprise client software and server software. Referring to FIG. 1, for example, in one embodiment of the invention, client software is executed on mobile device 120 and server software is executed on service provider 100.

Software environment 1120 may also comprise web browser software 1126 for communicating with the Internet. Further, software environment 1120 may comprise a user interface 1124 (e.g., a Graphical User Interface (GUI)) for receiving user commands and data. The commands and data received are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods that facilitate optimizing power consumption in a mobile device. In this exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but an exemplary implementation and are not related, or limited, to any particular computer, apparatus, or computer programming language. Rather, various types of general-purpose computing machines or devices may be used with logic code implemented in accordance with the teachings provided, herein. Further, the order in which the steps of the present method are performed is purely illustrative in nature. In fact, the steps can be performed in any order or in parallel, unless indicated otherwise in the present disclosure.

The method of the present invention may be performed in either hardware, software, or any combination thereof. In particular, the present method may be carried out by software, firmware, or macrocode operating on a computer or computers of any type. Additionally, software embodying the present invention may comprise computer instructions and be stored in a recording medium (e.g., memory stick, ROM, RAM, magnetic media, punched tape or card, compact disk (CD), DVD, etc.). Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention.

The embodiments described above are to be considered in all aspects as illustrative only and not restrictive in any manner. Thus, other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method of collective message transmission from a network server to a mobile device in a mobile communication network, the method comprising:
aggregating one or more messages generated for real-time transmission to the mobile device in a queue; and
collectively transmitting the one or more messages in the queue to the mobile device after a threshold delay period has lapsed.

2. The method of claim 1, wherein a default threshold delay period is set by at least one of the mobile device and the network server.

3. The method of claim 1, wherein the mobile device forwards a delay request to the network server.

4. The method of claim 3, wherein the delay request comprises the threshold delay period.

5. The method of claim 1, wherein the one or more messages are aggregated in the queue based on message type.

6. The method of claim 1, wherein the one or more messages are aggregated in the queue according to sender information.

7. The method of claim 1, wherein the mobile device is in a power saving mode when the one or more messages are aggregating in the queue.

8. The method of claim 1, wherein the mobile device switches from a power saving mode to a processing mode, to process the one or more messages that are collectively transmitted to the mobile device.

9. The method of claim 1, wherein the mobile device is a cellular telephone.

10. The method of claim 1, wherein the one or more messages comprise status information about a user using a device connected to the mobile communication network.

11. A system for optimizing power consumption in a mobile device connected to a communication network, the system comprising:
a mechanism for aggregating one or more messages directed to the mobile device in a queue; and
a mechanism for collectively transmitting the one or more messages in the queue to the mobile device after a threshold delay period has lapsed.

12. The system of claim 11, wherein the threshold a default threshold delay period is set by at least one of the mobile device and the network server.

13. The system of claim 11, wherein the mobile device forwards a delay request to a network server.

14. The system of claim 13, wherein the delay request comprises the threshold delay period.

15. The system of claim 1, wherein the one or more messages are aggregated in the queue based on message type.

16. The system of claim 1, wherein the one or more messages are aggregated in the queue according to sender information.

17. The system of claim 1, wherein the mobile device is in a power saving mode when the one or more messages are aggregating in the queue.

18. The system of claim 1, further comprising a power saving mechanism, wherein the mobile device switches from a power saving mode to a processing mode, to process the one or more messages that are collectively transmitted to the mobile device.

19. The system of claim 1, wherein the mobile device is a cellular telephone.

20. The system of claim 1, wherein the one or more messages comprise status information about a user using a device connected to the mobile communication network.
